(19) United States
(12) Patent Application Publication
(10) Pub. No.: US 2010/0259552 A1
(43) Pub. Date: Oct. 14, 2010

(54) FIELD COLOR SEQUENTIAL IMAGING METHOD AND RELATED TECHNOLOGY

(75) Inventor: Ching-Hsiang Hsu, Taipei (TW)

Correspondence Address: WPAT, PC;INTELLECTUAL PROPERTY ATTORNEYS, 7225 BEVERLY ST., ANNANDALE, VA, 22003, US

(73) Assignee: FARADAY TECHNOLOGY CORPORATION, Hsinchu (TW)

(21) Appl. No.: 12/757,660

(22) Filed: Apr. 9, 2010

(30) Foreign Application Priority Data
Apr. 10, 2009 (TW) 098112051

(51) Int. Cl. G09G 5/02

(52) U.S. Cl. 345/592

(57) ABSTRACT

Field color sequential (FCS) imaging method and technology/apparatus based on FCS principle are provided. In an embodiment, while displaying a frame based on FCS principle, the invention includes: extracting at least a monochrome subfield value and at least a mixed subfield value from each color channel of each pixel of the frame, writing corresponding monochrome subfield value of each pixel in association with a single color channel, and writing corresponding mixed subfield value of each pixel in association with a mixed color which is mixed by at least two color channels.

### FIELD OF THE INVENTION

The present invention relates to field color sequential (FCS) imaging method and related technology, and more particularly, to imaging method and related techniques reducing color break of color images combined based on FCS principle by inserting mixed subfield to reduce duration of monochrome subfield.

### BACKGROUND OF THE INVENTION

Display system is one of the most important human-machine interfaces, how to achieve better visualization with lower power has become a key issue for designers and developers of modern display system.

FCS (Field Color Sequential) principle is a technique for combining and displaying color images. Among various imaging techniques for displaying colors, one of them is combining/mixing colors in space. To combine colors in space, associated display panel is equipped with three sub-pixels, respectively corresponding to three prime colors, for each pixel of the image. By respectively controlling luminance/intensity of each sub-pixel, various colors can be combined spatially for each pixel. To implement such spatial color combination with current LCD (Liquid Crystal Display) panel, different sub-pixel is formed with different color filter film. For example, a green sub-pixel is covered with a color filter film for filtering red and blue; therefore, when a white backlight penetrates through the sub-pixel, only green component passes to make the sub-pixel show green.

However, spatial color combination also suffers lower power efficiency owing to aforementioned color filtering. Because color filtering filtrates a portion of light energy provided by white backlight, light energy of filtered components is wasted. Therefore, spatial color combination is difficult to match modern trend of low power. In addition, since each display unit of the panel for a pixel must contain three sub-pixels with three independent luminance controls, area of each display unit becomes large to decrease resolution of the panel/image.

Comparing to the spatial color combination, FCS principle can be understood as a temporal color combination. For a panel applying FCS principle, each display unit for a pixel only need a single intensity/luminance control, rather than three independent luminance controls for three sub-pixels in spatial color combination. In addition, each display unit for FCS principle color combination does not need color filter films. While applying FCS principle in a typical embodiment, a color image of a frame is displayed by: respectively writing luminance control of each display unit corresponding to red component of each pixel in association with a red light source, then respectively writing luminance control of each display unit corresponding to green component of each pixel in association with a green light source, and respectively writing luminance control of each display unit corresponding to blue component of each pixel in association with a blue light source. In other words, this embodiment sequentially displays red component image (also referred to as a red color field), green component image (a green color field) and blue component image (a blue color field) to combine/mix a color image of various colors by human visual persistence.

Based on FCS principle, because light sources of different (prime) colors are utilized for color combination, no color filter films are required, and therefore energy efficiency can be effectively increased. Under some applications, energy consumed based on FCS principles is only 30% of that based on spatial color combination. Also, resolution of image/panel based on FCS principle is raised since equivalently only one sub-pixel is needed for each display unit corresponding to each pixel.

However, aforementioned typical FCS embodiment has some disadvantages; one of them is known as color break. Please refer to FIG. 1 which demonstrates color break phenomenon. When a user observes motion images (video) displayed based on FCS principle, moving object (like the rectangular object shown in FIG. 1) will visually show extraordinary edges with abnormal colors around the object as one kind of phenomenon caused by color break. Color break leads to uncomfortable visual perception for users and thus affects visual quality of imaging based on FCS principle.

### SUMMARY OF THE INVENTION

Therefore, the invention provides an improved FCS imaging method and related technology for reducing impacts of aforementioned drawbacks. In embodiments of the invention, in addition to displaying color fields of three prime colors, additional mixed subfields are displayed in association with mixed colors, wherein each mixed color is combined by light sources of at least two prime colors. Duration of each single color field can be therefore decreased for reducing negative impacts of color break.

One objective of the invention is providing a method for processing at least a frame with an imaging device based on field color sequential (FCS) principle. Each frame corresponds to a plurality of pixels, each pixel corresponds to a plurality of color channels and respectively has a corresponding component on each color channel such that components of the plurality of pixels on a same color channel form a corresponding color field. And the method comprises: for a first color channel of the plurality of color channels, providing a corresponding monochrome subfield for each frame according to a color field corresponding to the first color channel; for a second color channel and a third color channel of the plurality of color channels, providing a corresponding mixed subfield for each frame according to color fields respectively corresponding to the second color channel and the third color channel; and, according to a predetermined order, writing the monochrome subfield of a frame in association with the first color channel, and writing the mixed subfield of the frame in association with a mixed color which is mixed by the second color channel and the third color channel.

In an embodiment of the method, the imaging device comprises a panel controller and a light controller, the light controller independently turns on and off each of a plurality of light sources, with each light source respectively corresponding to one of the plurality of color channels. While writing the monochrome subfield in association with the first color channel, the panel controller writes the monochrome subfield (to a panel) and the light controller exclusively turns on a light source of the first color channel synchronously. While writing the mixed subfield in association with the second and the third color channels, the panel controller writes the mixed subfield and the light controller synchronously turns on a light source of the second color channel and a light source of the third color channel.

In an embodiment of the method, wherein providing the mixed subfield for each frame includes: if a minimum among the plurality of components of a pixel and a minimum among the plurality of components of another pixel are different, providing two different mixed subfield values for the two pixels.

In an embodiment of the method, wherein each component of each pixel distributes between an upper bound and a lower bound; and providing the mixed subfield for each frame includes: if all the components of a pixel are greater than the lower bound, providing a mixed subfield value greater than the lower bound for the pixel.

In an embodiment of the method, wherein providing the monochrome subfield for each frame includes: providing a monochrome subfield value for a pixel which maps to a luminance not greater than a luminance mapped to the first color channel component of the pixel.

In an embodiment of the method, wherein providing the mixed subfield for each frame includes: providing a mixed subfield value for a pixel which maps to a luminance not greater than a luminance mapped to the second color channel component of the pixel and a luminance mapped to the third color channel component of the pixel.

In an embodiment of the invention, the first color channel, the second color channel and the third color channel are different.

In an embodiment of the invention, wherein providing the mixed subfield for each frame includes: for the first color channel, the second color channel and the third color channel, providing a corresponding mixed subfield for each frame according to color fields respectively corresponding to the first color channel, the second color channel and the third color channel. And writing the mixed subfield includes: writing the mixed subfield of the frame in association with a mixed color which is mixed by the first color channel, the second color channel and the third color channel.

In an embodiment of the method, wherein providing the mixed subfield for each frame comprises: for a pixel, obtaining a minimal component by comparing among the plurality of components of the pixel, and determining a mixed subfield value for the pixel according to the minimal component.

In an embodiment of the method, wherein providing the monochrome subfield for each frame comprises: for a pixel, obtaining a minimal component by comparing among the plurality of components of the pixel, and determining a monochrome subfield value for the pixel according to the minimal component and the first color channel component of the pixel.

In an embodiment of the method, it further includes: according to a complementary order, writing the monochrome subfield of a second frame in association with the first color channel and writing the mixed subfield of the second frame in association with a mixed color which is mixed by the second color channel and the third color channel; wherein the complementary order is different from the predetermined order.

Another objective of the invention is providing a method for processing at least a frame with an imaging device, comprising: for a first color channel of the plurality of color channels, extracting at least a monochrome subfield value and at least a mixed subfield value according to the first color channel component of each pixel of each frame; according to a predetermined order, writing the monochrome subfield value of each pixel of a frame in association with the first color channel and writing the mixed subfield value of each pixel of the frame in association with at least a second color channel, wherein the first color channel and the second color channel are different.

In an embodiment of the method, writing the mixed subfield value of each pixel includes: writing the mixed subfield value of each pixel in association with a color mixed by two second color channels.

In an embodiment of the method, writing the mixed subfield value of each pixel includes: writing the mixed subfield value of each pixel in association with a color mixed by the first color channel and at least a second color channel.

In an embodiment of the method, it further includes: obtaining a minimal component by comparing among the plurality of components of each pixel, and determining a mixed subfield value for each pixel according to the minimal component of each pixel.

In an embodiment of the method, it further includes: according to a complementary order, writing each monochrome subfield value of each pixel of a second frame in association with the first color channel and writing each mixed subfield value of each pixel of the second frame in association with at least the second color channel. The complementary order is different from the predetermined order.

Still another object of the invention is providing an imaging device for processing at least a frame based on FCS principle. Each frame corresponds to a plurality of pixels, a p-th pixel corresponding to quantity I of color channels with a component F_i(p) corresponding to an i-th color channel. The imaging device includes a calculator, a light controller and a panel controller.

The calculator provides quantity K of mixed subfield values with a k-th mixed subfield value CM_i_k(p) and quantity J of monochrome subfield values with a j-th monochrome subfield value C_i_j(p) for the p-th pixel according to the component F_i(p) of the p-th pixel of each frame, wherein both K and J are greater than or equal to 1.

The light controller is capable of independently turning on and off each of a plurality of light sources, with each light source respectively corresponding to one of the plurality of color channels. When the light controller exclusively turns on a light source of the i-th color channel, the panel controller synchronously writes the monochrome subfield values C_i_j(p) of a frame. And when the light controller turns on at least two light sources of different color channels, the panel controller synchronously writes the mixed subfield values CM_i_k(p) of the frame.

In an embodiment of the imaging device, it further includes a comparator obtaining a minimal component for the p-th pixel among components of the p-th pixel corresponding to the quantity I of color channels. For the p-th pixel, assuming the comparator obtains the minimal component F_im(p) from an im-th color channel, the calculator further determines the mixed subfield value CM_i_k(p) and the monochrome subfield value C_i_j(p) according to the minimal component F_im(p). For example, the calculator can first calculate each mixed subfield value CM_im_k(p) and each monochrome subfield value C_im_j(p) of the im-th color channel, then calculate at least a mixed subfield value CM_i_k(p) for another i-th color channel according to each mixed subfield value CM_im_k(p), and further calculate each monochrome subfield value C_i_j(p) according to each component F_i(p). In an embodiment, the calculator sets a mixed subfield value CM_i_k1(p) of the i-th color channel equal to a mixed subfield value CM_im_k2(p) of the im-th color channel; in another embodiment, the calculator sets all quantity K of mixed subfield values CM_im_k(p) equal to each other.

In an embodiment of the imaging device, it further includes a luminance map for mapping each component F_i(p) to a corresponding luminance.

In an embodiment of the imaging device, the panel controller synchronously writes the monochrome subfield value C_i_j(p) of a frame when the light controller exclusively turns on a light source of the i-th color channel, and synchronously writes the mixed subfield value CM_i_k(p) of the frame when the light controller turns on at least two light sources of different color channels according to a predetermined order. Also, the panel controller further writes the monochrome subfield value C_i_j(p) of a second frame when the light controller exclusively turns on a light source of the i-th color channel, and synchronously writes the mixed subfield value CM_i_k(p) of the second frame when the light controller turns on at least two light sources of different color channels according to a complementary order different from the predetermined order.

### BRIEF DESCRIPTION OF THE DRAWINGS

The above contents of the present invention will become more readily apparent to those ordinarily skilled in the art after reviewing the following detailed description and accompanying drawings, in which:

FIG. 1 illustrates phenomenon of color break;

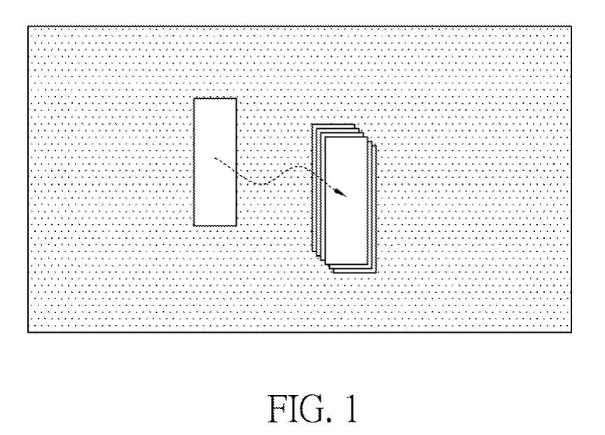

FIG. 2 and FIG. 3 illustrate causes of color break;

FIG. 4 and FIG. 5 demonstrate how the invention improves color break;

FIG. 6 shows a flow based on FIG. 4 according to an embodiment of the invention;

FIG. 7 illustrates a frame combined by subfields according to the embodiment shown in FIG. 6;

FIG. 8 shows a flow based on FIG. 5 according to an embodiment of the invention;

FIG. 9 illustrates two consecutive frames combined by subfields according to the embodiment shown in FIG. 8; and

FIG. 10 illustrates an imaging device according to an embodiment of the invention installed in a display system based on FCS principle.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

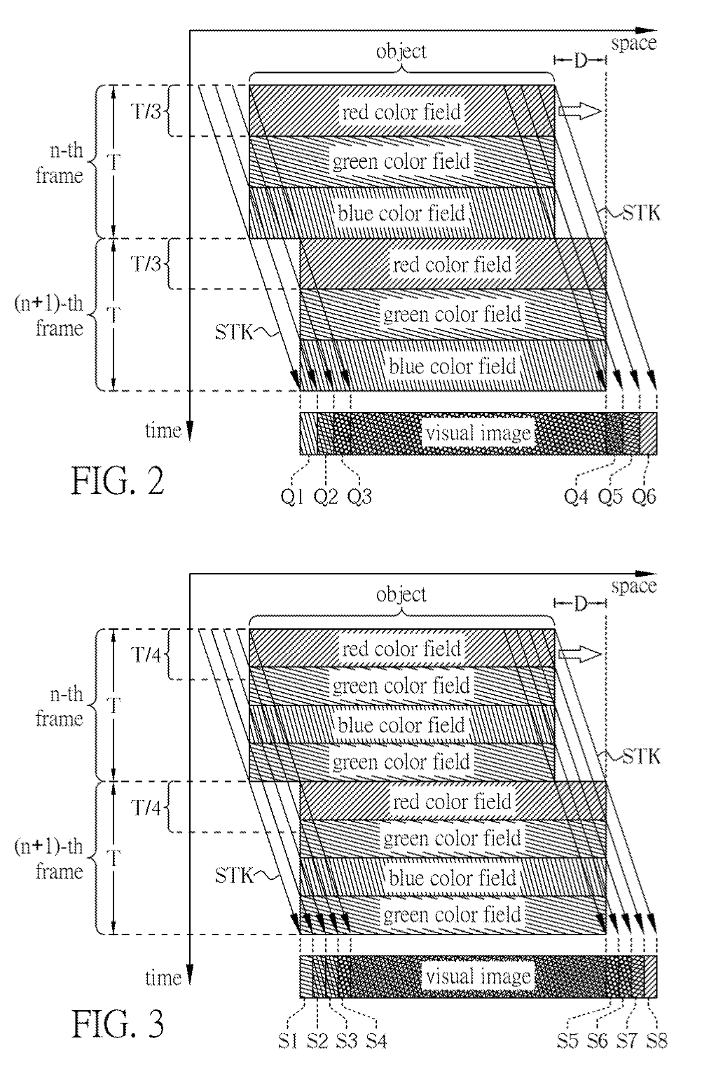

Please refer to FIG. 2 which illustrates cause of color break when the typical embodiment is applied for displaying motion images based on FCS principle. The transverse axis of FIG. 2 represents space (spatial location), and the longitudinal axis is time. As described, when an object is to be displayed (say, against a black background), the typical FCS imaging method sequentially displays a red color field, a green color field and a blue color field along the time axis respectively for the object's three components of prime colors. If a frame lasts duration T, each color field lasts a duration T/3. Assuming the object is moving to the right of the image in space, then, comparing to the location in the n-th frame, the location of the object will shift to the right by a distance D in the next frame (i.e., the (n+1)-th frame). Similar to what applies in the n-th frame, the typical FCS imaging method combines the color of the object with three color fields of three prime colors in the (n+1)-th frame.

When a user observes the motion images of the moving object, because human eyes automatically tracks edges of the object, an integral track STK extending both in time and in space is equivalently formed; and the visual image saw by human eyes is an integration (summation/accumulation) by visual persistence along the integral track STK. As shown in FIG. 2, because temporal distribution of color fields integrates with shift in spatial locations, human eyes will sense sections Q1, Q2 to Q6 on the left and right edges of the visual image of the object; these sections will show extraordinary edges of the object with abnormal colors and then lead to color break. For example, because the integral tracks STK forming the section Q1 only pass through blue color field of the object, the section Q1 appears blue with a look like a blue edge of the object. The integral tracks STK integrating the section Q2 pass through blue and green color fields only, so the section Q2 has a color of cyan. For the section Q3, its corresponding integral tracks STK begin to pass through the red color field to integrate all red, green and blue color fields, so its color starts to approximate actual color of the object. Between sections Q3 and Q4, true color of the object is shown since corresponding integral tracks completely pass through all color fields which combine real color of the object. For the section Q4, corresponding integral tracks start to leave the blue color field, so blue component fades out. Similar to the section Q2, the section Q5 only accumulates red and green color fields, so its looks like a yellow edge near the right edge of the object. The section Q6 integrates red color field only to be shown as a red right edge.

Since each of the sections Q1 and Q6 has only one component of a prime color and each of the sections Q2 and Q5 includes only two components, these sections do not completely combine all three prime color components of the moving object. These sections will therefore show high color contrast against original color of the object to look like edges of abnormal colors. In fact, not only moving objects in motion images but also still objects suffer color break owing to fluctuation of line of vision.

Please refer to FIG. 3 which illustrates how another FCS imaging method shows a moving object. In this FCS imaging method, green color fields will repeat twice in time, so a color image is combined by a red, a green, a blue and again a green color fields. Since a frame is mixed by four color fields, each color field lasts duration of T/4. According to analysis applied in FIG. 2, sections S1 to S4, and sections S5 to S8 will be observed in FIG. 3 while displaying an object moving distance D between two consecutive frames. Comparing to sections Q1 to Q6 of FIG. 2 respectively extending distance D/3 in space, each of sections S1 to S8 shown in FIG. 3 merely extends distance D/4. However, each of the sections S1 and S8 still has only one prime color (green and red, respectively), each of the sections S2 and S3 contains only two prime colors (blue and green), also the section S7 combines only two components of red and green out of all three components of three prime colors. Therefore, the FCS imaging method of FIG. 3 only decreases extend of color break sections but does not avoid abnormal edges of high color contrast.

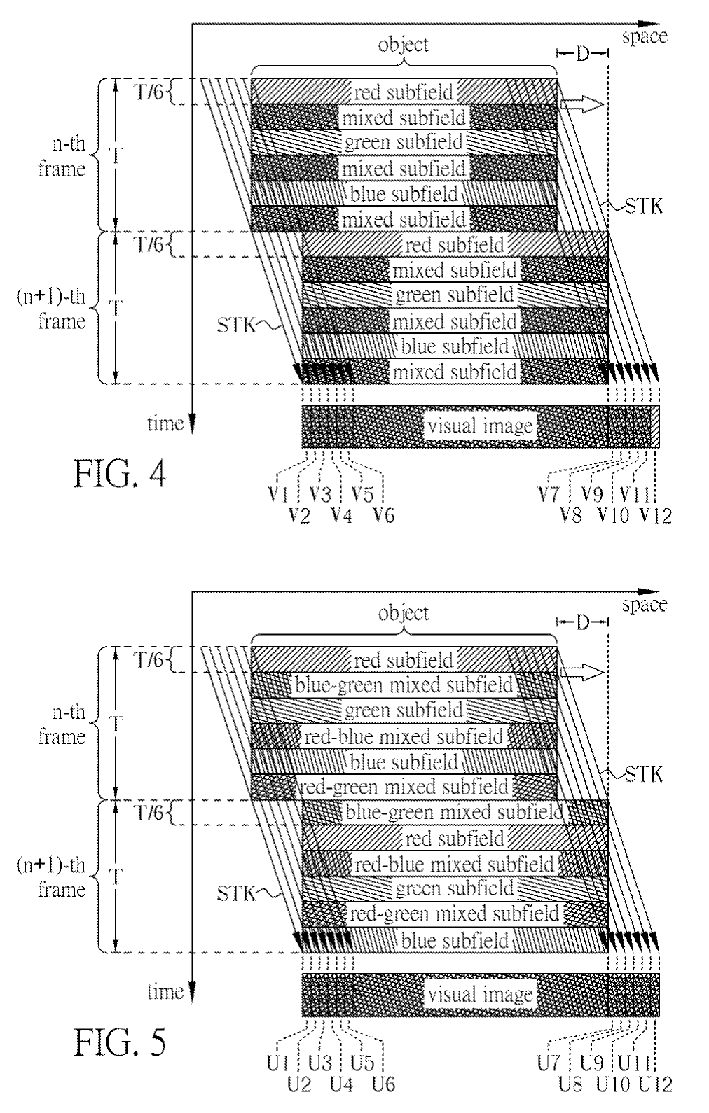

Please refer to FIG. 4 and FIG. 5, which depict improving of color break according to two embodiments of the invention. As shown in FIG. 4, in addition to a red subfield (i.e., a monochrome subfield of red), a green subfield and a blue subfield respectively displayed in association with red light source, green light source and blue light source, the invention inserts additional mixed subfields among the monochrome red, green and blue subfields of three prime colors. Each of these mixed subfields is displayed in association with a mixed color. In an embodiment of the invention, each mixed subfield is synchronously displayed by simultaneous combination of the red light source, the blue light source and the green light source. In other words, each mixed subfield is displayed with all three prime colors of red, green and blue.

To compare improvement of color break, analysis of FIG. 2 and FIG. 3 is followed in FIG. 4 for considering sections near edges of an object moving distance D between two consecutive frames. In FIG. 4, sections V1 to V12 will be observed due to integral tracks of visual persistence. Because each frame corresponds to six subfields, each of the sections V1 to V12 extends a shorter distance of D/6. Also, as integral tracks in FIG. 4 show, each of the sections V1 to V11 will contain components of all three prime colors due to insertion of mixed subfields, except the section V12 which has a single prime color (red in this example). That is, according to the embodiment of the invention shown in FIG. 4, only one short section V12 will show abnormal color of higher contrast, and thus improvement of color break is achieved.

According to another embodiment of the invention illustrated in FIG. 5, color break is improved by inserting three additional mixed subfields with components respectively complementary to three prime colors among three monochrome subfields of three prime colors, as well as by displaying these monochrome and mixed subfields in different orders between different frames. As shown in FIG. 5, a blue-green mixed subfield is inserted after the red subfield (e.g., between the red subfield and the green subfield). This blue-green mixed subfield will be displayed in association with simultaneous green light source and blue light source. Note that a combination of blue and green is complementary to red. Similarly, a red-blue mixed subfield with components complementary to green is inserted after the green subfield, as well as a red-green mixed subfield complementary to blue is inserted after the monochrome subfield of blue. For the n-th frame (e.g., an even n), a predetermined order is followed to sequentially display the red subfield and the blue-green mixed subfield, the green subfield and the red-blue mixed subfield, the blue subfield and the red-green mixed subfield. For the next frame, the (n+1)-th frame, a different complementary order is followed to display the subfields of the (n+1)-th frame as: the blue-green mixed subfield and the red subfield, the red-blue mixed subfield and the green subfield, then the red-green mixed subfield and the blue subfield, as shown in FIG. 5.

With similar analysis for FIG. 2 to FIG. 4, color break improvement of the invention can be understood by examining an object moving distance D between two consecutive frames in FIG. 5. As FIG. 5 shows, though sections U1 to U12 are still observed in visual image of the object following various integral tracks STK, all the sections U1 to U12 contain components of all three prime colors. In other words, edge sections with only one or two components out of all three prime colors can be avoided by the embodiment of FIG. 5 to effectively improve edges of high color contrast owing to edge sections of color break. For example, though the integral tracks STK corresponding to the section U12 of FIG. 5 only pass the red subfield in a previous frame (the n-th frame), they will accumulate complementary components of blue and green in the next frame (the (n+1)-th frame) to avoid abnormal color contrast by collecting all components of three prime colors, as the blue-green mixed subfield is arranged for the red subfield by the complementary order of the (n+1)-th frame.

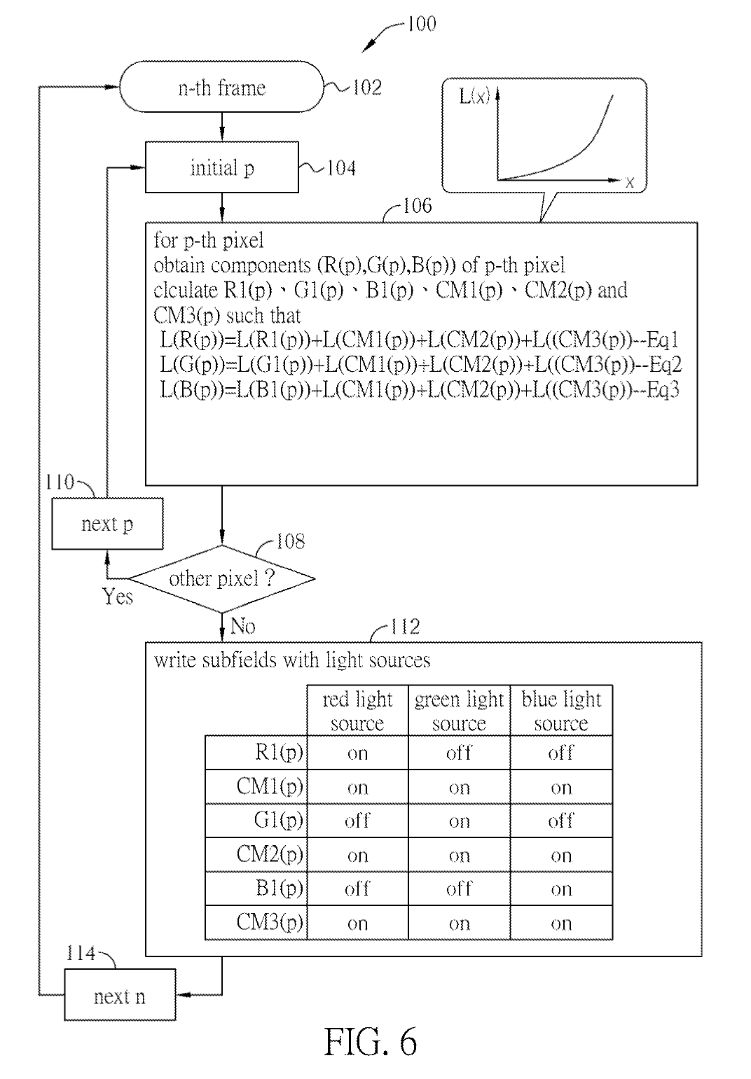

Further details of the invention will be discussed as follows. Please refer to FIG. 6, which illustrates a flow 100 of an FCS imaging method according to one embodiment of the invention for improving color break based on disclosure shown in FIG. 4. Major steps included in the flow 100 can be described as follows.
Step 102: for the n-th frame, start following steps.
Step 104: set an initial value for an index p referring to the p-th pixel of the n-th frame.
Step 106: for the p-th pixel, first obtain all components R(p), G(p) and B(p) on all color channels (e.g., three color channels of three prime colors), and calculate three monochrome subfield values R1(p), G1(p) and B1(p) and three mixed subfield values CM1(p), CM2(p) and CM3(p) based on the components R(p), G(p) and B(p) as well as a predetermined function L(.), such that the following three equations, respectively referred as Eq1, Eq2 and Eq3, are satisfied:

L(R(p))=L(R1(p))+L(CM1(p))+L(CM2(p))+L(CM3(p)) Eq1

L(G(p))=L(G1(p))+L(CM1(p))+L(CM2(p))+L(CM3(p)) Eq2

L(B(p))=L(B1(p))+L(CM1(p))+L(CM2(p))+L(CM3(p)) Eq3
Where the predetermined function L(.) is a function maps a value code of a component to a corresponding luminance. For example, this predetermined function L(.) can be the gamma function known in the industry. An exemplary mapping curve of the predetermined function L(.), which maps an variable x to a corresponding luminance value L(x), is also shown in FIG. 6.
An embodiment of this step 106 can be further described with following steps (these steps 106-1 to 106-5 are not shown in FIG. 6).
Step 106-1: find a minimum among the components R(p), G(p) and B(p). For convenience of explanation, it is assumed that the minimal component is the component B(p) of blue; in other words, component B(p) is not greater than either components R(p) or G(p).
Step 106-2: calculate L(B(p)), L(G(p)) and L(R(p)) based on the predetermined function L(.).
Step 106-3: because the blue component B(p) is the minimum among all components of prime colors, L(B1(p)), L(CM1(p)), L(CM2(p)) and L(CM3(p)) are first calculated according to the equation Eq3, which corresponds to the blue component of a pixel. According to the equation Eq3, L(B(p)) is divided by 4 to obtain L(B1(p)), L(CM1(p)), L(CM2(p)) and L(CM3(p)), i.e., let L(B1(p))=L(CM1(p))=L(CM2(p))=L(CM3(p))=L(B(p))/4. For a hardware circuitry implementation, this step can be readily implemented with a simple shifter for performing bit shift on binary L(B(p)) to quickly obtain L(B(p))/4, which is then assigned to L(B1(p)), L(CM1(p)), L(CM2(p)) and L(CM3(p)) to complete this step.
Step 106-4: after L(CM1(p)), L(CM2(p)) and L(CM3(p)) are obtained, L(R1(p)) and L(G1(p)) respectively corresponding to monochrome subfield values of red color channel and green color channel can be solved via equations Eq1 and Eq2. As an example, L(R1(p))=L(R(p))−L(CM1(p))−L(CM2(p))−L(CM3(p)) according to the equation Eq1 of the red color channel.
Step 106-5: according to the predetermined function L(.) and solved values L(R1(p)), L(G1(p)), L(B1(p)), L(CM1(p)), L(CM2(p)) and L(CM3(p)), perform reverse mapping for solving subfield values R1(p), G1(p), B1(p), CM1(p), CM2(p) and CM3(p) to finish step 106.
The predetermined function L(.) can be implemented with LUT (Look-Up Table) of software or hardware, so a variable x can be mapped to a corresponding luminance L(x), and a know L(x) can also be reversely mapped back to its corresponding argument x readily and quickly.
Under proper arrangement, order for performing the steps 106-1 to 106-5 can be exchanged. For example, step 106-2 can be done before step 106-1. As components of each pixel vary, order of applying equations for solving the monochrome and mixed subfield values alters too. For example, if the red component R(p) is minimum for another pixel, equation Eq1 is first followed in step 106 to solve monochrome subfield value and mixed subfield values corresponding to the red color channel, then equations Eq2 and Eq3 are followed for monochrome subfield values of green and blue.
Step 108: check whether there are other pixels to be processed in the n-th frame; if true, go to step 110; otherwise, go to step 112.
Step 110: update the index p for pointing to next pixel to be processed, and go back to step 104 for iteration.
Step 112: By collecting monochrome subfield values R1(p), G1(p), and B1(p), and mixed subfield values CM1(p), CM2(p) and CM3(p) of all pixels of the n-th frame, monochrome subfields and mixed subfields of the n-th frame are obtained. Then, each monochrome subfield can be written in association with corresponding color channel, and each mixed subfield can be written in association with corresponding color mixed by all color channels.
   The flow 100 of the invention applies to an imaging device of an FCS display system, such as a timing controller (or T-con in short) of an LCD displayer which operates based on FCS principle; and “writing” can refer to “writing a monochrome subfield value or a mixed subfield value of each pixel to a source driver the LCD displayer,” such that an LCD panel of the LCD displayer can demonstrate a luminance distribution corresponding to each of the monochrome subfields and mixed subfields; with proper control of light sources of different color channels, each monochrome subfield of a prime color and each mixed subfield of a mixed color can be displayed.
   With a table, step 112 shown in FIG. 6 demonstrates an embodiment of the invention for displaying monochrome subfields with prime colors and displaying mixed subfields with mixed colors. In this embodiment, the monochrome subfield R1(p) corresponding to red is first written in association with red color channel by synchronously turning on red light source while keeping green and blue light sources off simultaneously. Next, by turning on light sources of all the red, green and blue color channels, the first mixed subfield CM1(p) is written in association with a color mixed by all three color channels. Then the monochrome subfield G1(p) corresponding to the green color channel is written with green light source on, red and blue light sources off. Another mixed subfield CM2(p) is next written in association with mixed color combined by all three color channels. By turning on blue light source and keeping green and red light sources off, the monochrome subfield B1(p) corresponding to the blue color channel is synchronously written. Finally, by turning on all light sources of red, green and blue, the third mixed subfield CM3(p) is synchronously written to finish processing (displaying) of the n-th frame. Flow 100 can then proceed to step 114.
Step 114: if there are consecutive frames to be processed, update the index n for pointing to the next frame, and go to step 102 for iteration.

According to above discussion, it is understood that at least a monochrome subfield value and at least a mixed subfield value are extracted from each component of a pixel; in other words, each component of each color channel is distributed to corresponding monochrome subfield value and mixed subfield value(s). For example, it is observed in step 112 that the red light source will turn on four times respectively for writing of the monochrome subfield R1(p) and the mixed subfields CM1(p), CM2(p) and CM3(p), such that these subfield values R1(p), CM1(p), CM2(p) and CM3(p) accumulate to an equivalent of the original component R(p), as implied by equation Eq1 of step 106.

The order for writing/displaying each subfield in step 112 can be changed. For example, these subfields can be written in an order of CM1(p), R1(p), CM2(p), G1(p), CM3(p) and B1(p) with proper light source control.

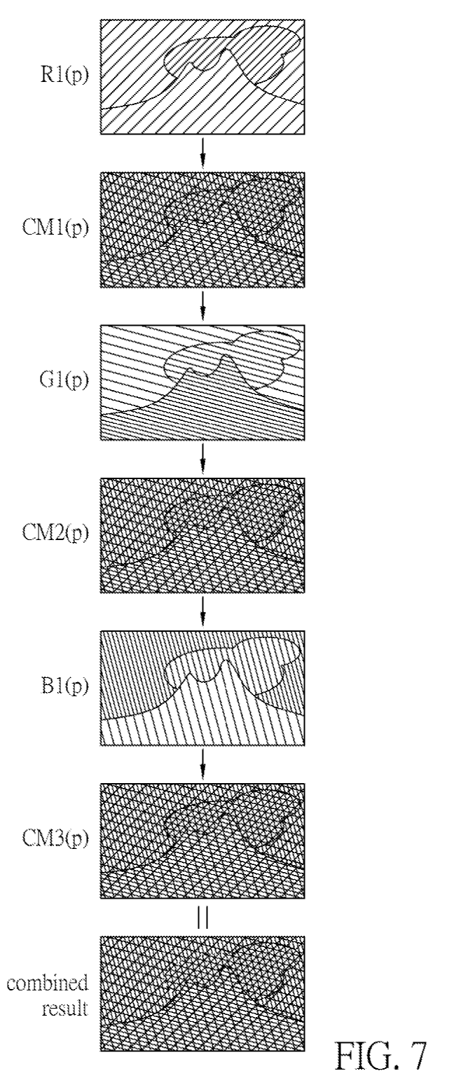

Following discussion of FIG. 6, please refer to FIG. 7 which depicts how monochrome subfields and mixed subfields of a frame are combined to display the frame. Because components R(p), G(p) and B(p) of different pixels are potentially different, each monochrome subfield value and each mixed subfield value of different pixels are potentially different. For example, as described in step 106, if a minimal component of a pixel is different from that of another pixel, these two pixels will have different values in each of the resultant mixed subfields. Therefore, each of the mixed subfields CM1(p), CM2(p) and CM3(p) is inhomogeneous; that is, each mixed subfield has various values distributed with various pixels. While writing/displaying each mixed subfield, although light sources of all three prime colors turn on to provide a mixed color of white, each of the mixed subfield CM1(p), CM2(p) and CM3(p) demonstrates inhomogeneous distribution of various gray levels instead of a uniform white or black, due to inhomogeneous nature of each mixed subfield. Generally speaking, each component of each pixel distributes between an upper bound and a lower bound, e.g., between decimal 255 and decimal 0. As described in step 106 of the invention, while providing each mixed subfield for each frame, if all components of a pixel are greater than the lower bound, the value corresponding to the pixel in each mixed subfield (i.e., mixed subfield value of the pixel) will be greater than the lower bound, such that resultant mixed subfields are not of uniform black or white.

Also as described in step 106, since total luminance of each monochrome subfield and corresponding mixed subfields corresponding to a color channel is equivalent to original luminance of the component corresponding to the color channel, luminance mapped to a monochrome subfield value (e.g., L(R1(p))) of a pixel will not be greater than that mapped to a component of same color channel (e.g., L(R(p))) of the same pixel, and luminance mapped to a mixed subfield value (e.g., L(CM1(p))) of a pixel will not be greater than that mapped to each component (e.g., L(G(p)) or L(B(p))) of the same pixel.

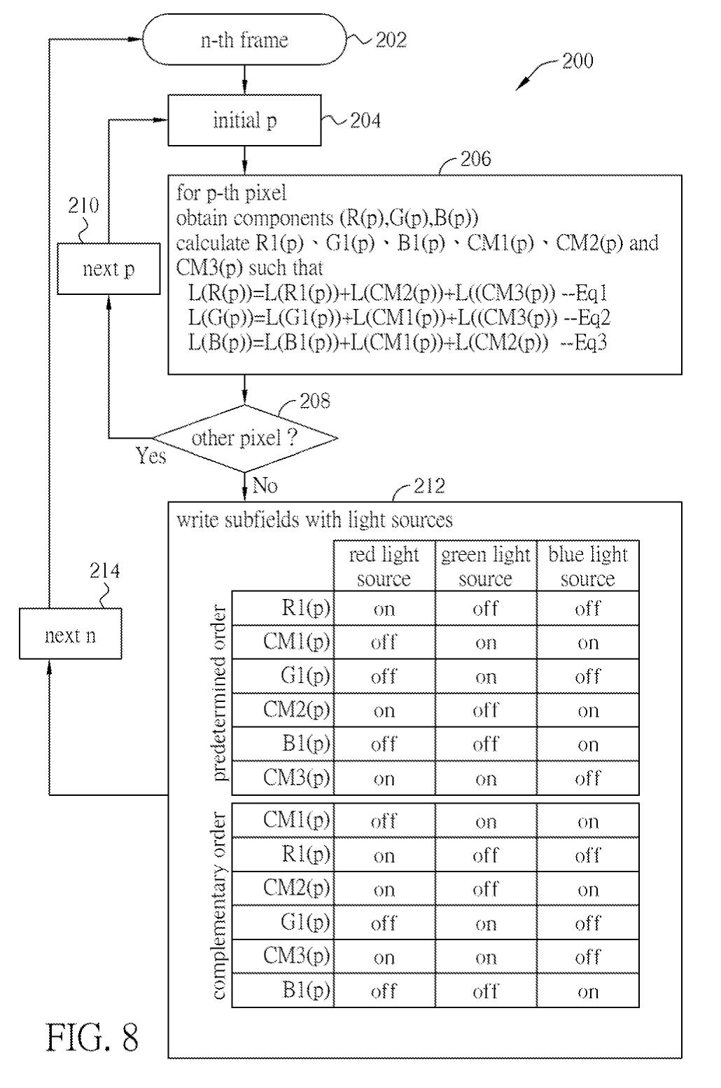

Please refer to FIG. 8, which illustrates a flow 200 of an FCS imaging method according to another embodiment of the invention for improving color break based on disclosure shown in FIG. 5. Dominant steps included in the flow 200 can be described as follows.
Step 202: for the n-th frame, start following steps.
Step 204: set an initial value for an index p referring to the p-th pixel of the n-th frame.
Step 206: for the p-th pixel, first obtain all components R(p), G(p) and B(p) on all color channels (e.g., three color channels of three prime colors), and calculate three monochrome subfield values R1(p), G1(p) and B1(p) and three mixed subfield values CM1(p), CM2(p) and CM3(p) based on the components R(p), G(p) and B(p) as well as a predetermined function L(.), such that the following three equations, respectively referred as Eq1, Eq2 and Eq3, are satisfied:

L(R(p))=L(R1(p))+L(CM2(p))+L(CM3(p)) Eq1

L(G(p))=L(G1(p))+L(CM1(p))+L(CM3(p)) Eq2

L(B(p))=L(B1(p))+L(CM1(p))+L(CM2(p)) Eq3
Similar to step 106 of FIG. 6, the predetermined function L(.) is a function maps a component value code to a corresponding luminance.
An embodiment of this step 206 can be further described with following steps (these steps 206-1 to 206-5 are not shown in FIG. 8).
Step 206-1: find a minimum among the components R(p), G(p) and B(p). For convenience of explanation, it is assumed that the minimal component is the component B(p) of the blue color channel; in other words, component B(p) is not greater than either components R(p) or G(p).
Step 206-2: calculate L(B(p)), L(G(p)) and L(R(p)) based on the predetermined function L(.).
Step 206-3: since the blue component B(p) is the minimum among all components of prime colors, values L(B1(p)), L(CM1(p)) and L(CM2(p)) are first calculated according to the equation Eq3, which corresponds to the blue component of a pixel. According to the equation Eq3, L(B(p)) is divided by 4 to obtain L(B1(p)), L(CM1(p)) and L(CM2(p)), i.e., let L(B1(p))=L(B(p))/2 and L(CM1(p))=L(CM2(p))=L(B(p))/4. For a hardware circuitry implementation, this step can be readily implemented with a simple shifter for performing bit shift on binary L(B(p)) to quickly obtain L(B(p))/2 and L(B(p))/4, which are then respectively assigned to L(B1(p)) and L(CM1(p)), L(CM2(p)) to complete this step.
Step 206-4: after L(CM1(p)) and L(CM2(p)) are obtained, L(R1(p)) and L(G1(p)) respectively corresponding to monochrome subfield values of red color channel and green color channel can be solved via equations Eq1 and Eq2. For example, assuming the green component G(p) is not greater than the red component R(p), then L(G1(p))=L(CM3(p))=(L(G(p))−L(CM1(p))/2 according to the equation Eq2 of the green color channel, and finally L(R1(p))=L(R(p))−L(CM2(p))−L(CM3(p)) according to equation Eq1.
Step 206-5: according to the predetermined function L(.) and solved values L(R1(p)), L(G1(p)), L(B1(p)), L(CM1(p)), L(CM2(p)) and L(CM3(p)), perform reverse mapping for solving R1(p), G1(p), B1(p), CM1(p), CM2(p), and CM3(p), to finish step 206.
Under proper arrangement, order for performing the steps 206-1 to 206-5 can be exchanged.
Step 208: check whether there are other pixels to be processed in the n-th frame; if true, go to step 210; otherwise, go to step 212.
Step 210: update the index p for pointing to next pixel to be processed, and go back to step 204 for iteration.
Step 212: By collecting monochrome subfield values R1(p), G1(p), and B1(p), and mixed subfield values CM1(p), CM2(p) and CM3(p) of all pixels of the n-th frame, monochrome subfields and mixed subfields of the n-th frame are obtained. Then, each monochrome subfield can be written in association with corresponding color channel, and each mixed subfield can be written in association with corresponding color mixed by two color channels.
   In an embodiment of the invention, step 212 alternatively switches between a predetermined order and a different complementary order for writing each monochrome field and mixed subfield according to value of the index n. For example, the predetermined order is followed if the index n is even, and the complementary order is followed if the index n is an odd number.
   With a table, step 212 shown in FIG. 8 also demonstrates an embodiment of the invention for displaying monochrome subfields with prime colors and displaying mixed subfield with mixed colors in the predetermined order and the complementary order.
   According to the predetermined order, the monochrome subfield R1(p) corresponding to red is first written in association with red color channel by synchronously turning on red light source while keeping green and blue light sources off simultaneously. Next, by turning on light sources of green and blue with red light source off, the blue-green mixed subfield CM1(p) is written in association with a color mixed by blue and green color channels. Then the monochrome subfield G1(p) corresponding to the green color channel is written with green light source on, red and blue light sources off. The red-blue mixed subfield CM2(p) is next written in association with mixed color combined by red and blue. By turning on blue light source and keeping green and red light sources off, the monochrome subfield B1(p) corresponding to the blue color channel is synchronously written. Finally, by turning on light sources of red and green as well as turning off the blue light source, the red-green mixed subfield CM3(p) is synchronously written.
   On the other hand, in the complementary order, the blue-green mixed subfield CM1(p) is first written with green and blue light sources on and red light source off, and the monochrome subfield R1(p) corresponding to the red color channel is written with only red light source on. Next, the red-blue mixed subfield CM2(p) is written with red and blue light sources on and green light source off, and the green monochrome subfield G1(p) is written with green light source exclusively turned on. Then the red-green mixed subfield CM3(p) is written synchronously with the blue light source off and the red and green light sources simultaneously on. Finally, the monochrome subfield B1(p) corresponding to the blue channel is written with the blue light source on and the green and red light sources off.
   As each monochrome subfield and each mixed subfield of a frame are written in the predetermined order or the complementary order, processing (displaying) of the n-th frame finishes. Flow 200 can then proceed to step 214.
Step 214: if there are consecutive frames to be processed, update the index n for point to next frame, and go to step 202 for iteration.

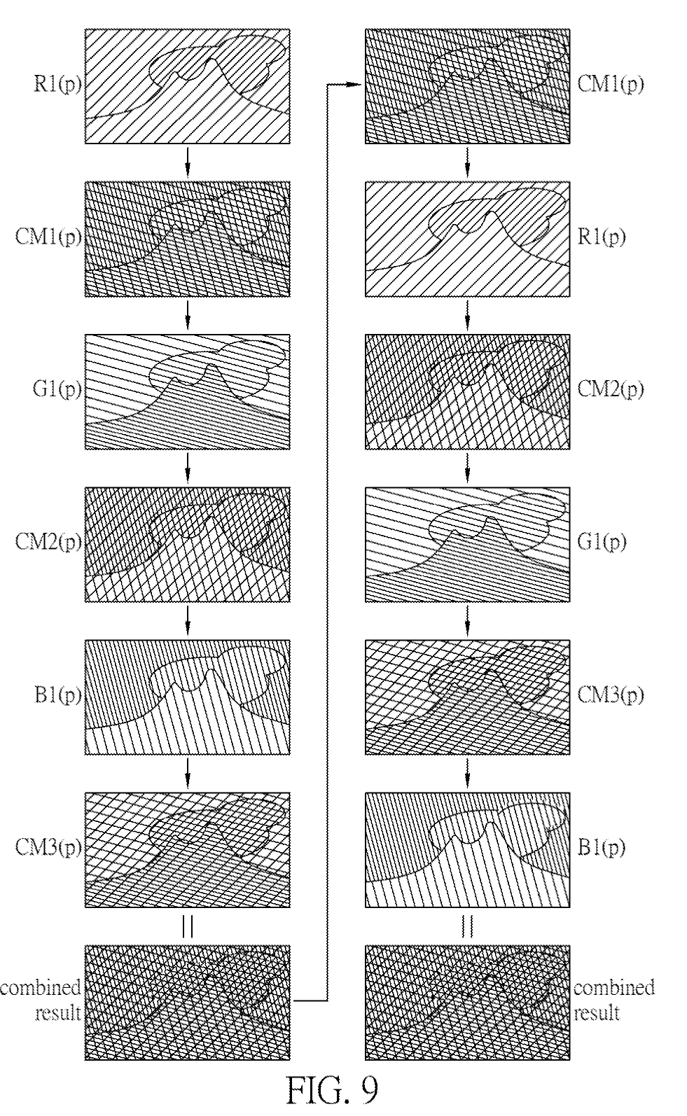

Following FIG. 8, please refer to FIG. 9, which demonstrates two consecutive frames respectively combined by their respective subfields. By alternating between the predetermined order and the complementary order, color break can be improved based on disclosure of FIG. 5.

In step 106 of FIG. 6 and step 206 of FIG. 8, the equation adopted for solving each monochrome subfield value and each mixed subfield value can be generalized as:

L(F_{—}i(p))={w_{—}i_{—}1*L(C_{—}i_{—}1(p))+w_{—}i_{—}2*L(C_{—}i_{—}2(p))+ . . . +w_{—}i_{—}j*L(C_{—}i_{—}j(p))+ . . . +w_{—}i_{—}J*L(C_{—}i_{—}J(p))}+{W_{—}i_{—}1*L(CM_{—}i_{—}1(p))+W_{—}i_{—}2*L(CM_{—}i_{—}2(p))+ . . . +W_{—}i_{—}k*L(CM_{—}i_{—}k(p))+ . . . +W_{—}i_{—}K*L(CM_{—}i_{—}K(p))}

where the index i indicates the i-th color channel, e.g., i=1 for red, i=2 for green and i=3 for blue. The value F_i(p) is the component of the p-th pixel on the i-th color channel, e.g., F_1(p)=R(p), F_2(p)=G(p) and F_3(p)=B(p). The value C_i_j(p) represents the j-th monochrome subfield value of the i-th color channel with index j ranging from 1 to J, implying quantity J of monochrome subfields. The weighting w_i_j introduces weighting for each monochrome subfield value C_i_j(p), the weighting w_i_j can be a constant. Similarly, the k-th mixed subfield value CM_i_k(p) corresponding to the i-th color channel has an index k ranging from 1 to K with quantity K of mixed subfields, and each weighting W_i_k weights the mixed subfield value. For the embodiment of FIG. 6, the quantity J is set to 1 and the quantity K is set to 3 (so R1(p)=C_1_1(p), G1(p)=C_2_1(p) and B1(p)=C_3_1(p)), also CM_i1_k(p)=CM_i2_k(p)=CMk(p) for different i1-th color channel and i2-th color channel, and each weighting w_i_j=1 and W_i_j=1 for all i, j and k. Same setting applies to the embodiment in FIG. 8 with the weighting W_i_k=0 for k=i in addition. From the generalized equation, it can be understood that multiple monochrome subfields on each color channel are possible. In addition, the quantities J and K can vary with the index i. For example, the green color channel can have two monochrome subfields (J=2), and each of the blue and red channels has only one monochrome subfield (J=1). The weighting w_i_k can be different or identical for different indices i and/or j, the weighting W_i_k can also be different or identical for different indices i and/or j. With the aforementioned equations applied in the invention, it is understood that the invention not only reduces duration of monochrome subfields by insertion of mixed subfields, but also reduces luminance of displaying the monochrome subfields, both help to improve color break.

Similar to steps 106-1 to 106-4 or steps 206-1 to 206-4, the minimum among all the components F_i(p) of the p-th pixel can be first obtained by comparison while solving subfield values of the generalized equation. For example, assume the component F_im(p) of the im-th color channel is minimal, corresponding monochrome subfield value C_im_j(p) and mixed subfield value CM_im_k(p) can be first obtained based on the generalized equation with i=im, as disclosed in step 106-3 or 206-3. Then each subfield for other index i (not equal to im) can be calculated. For example, at least a mixed subfield CM_i_k1(p) is set to the known mixed subfield CM_im_k2(p), then other subfields, such as the monochrome subfield C_i_j(k), can be solved, as disclosed in step 106-4 or 206-4.

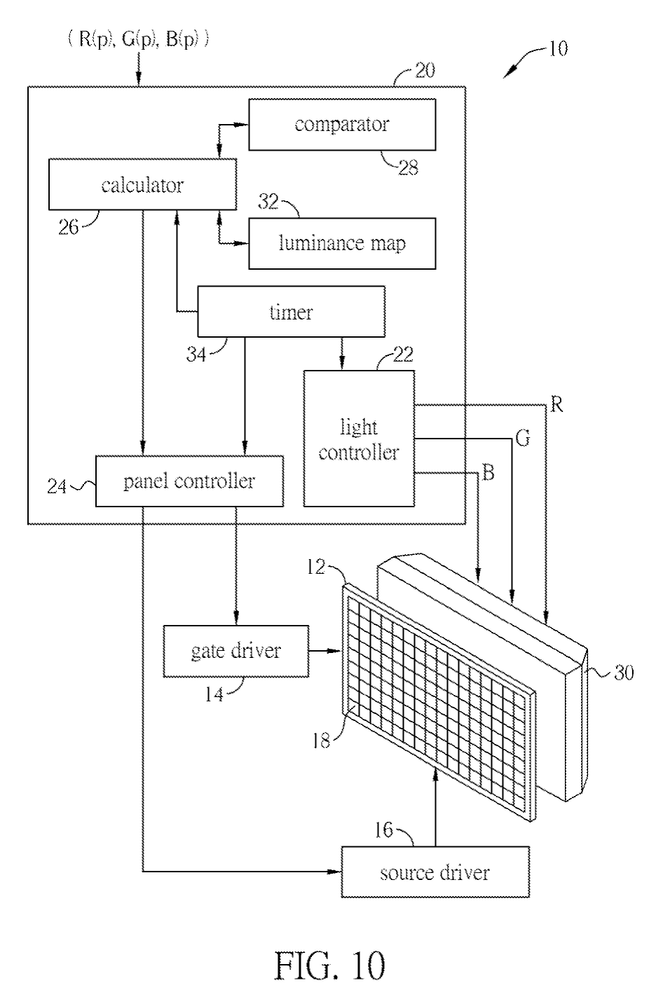

Please refer to FIG. 10, which illustrates an imaging device 20 in an FCS display device/system 10 according to an embodiment of the invention. The FCS display system 10 can be an LCD displayer based on FCS principle, or a projector based on FCS principle, wherein the FCS display system 10 has a panel 12, a light module 30, a gate driver 14 and a source driver 16. The light module 30 can be a backlight module for providing light to the panel 12. The panel 12 includes a plurality of display units 18, each display unit 18 corresponds to a pixel of a frame. As previously discussed, the display unit for displaying color images based on FCS principle does not need sub-pixels of three prime colors; each display unit is a sub-pixel. For example, the panel 12 can be a Thin-File Transistor (TFT) LCD panel with a single TFT for an LCD cell in each display unit; and the gate driver 14 and the source driver 16 respectively control gate and source of each TFT in each display unit for changing transparency (light transmittance) of each display unit to display images of various luminance.

To implement FCS principle, the light module 30 includes independent light sources respectively for each color channel, such as a red light source, a green light source and a blue light source. Each light source of the light module 30 can be independently turned on and off; for example, the red light source can be exclusively turned on, or the green and blue light sources can be simultaneous turned on to combine a mixed color complementary to red, or all the light sources of red, green and blue can be simultaneously turned on to provide a mixed light of white. The light module 30 can be implemented by optical diffuser and LEDs (Light Emission Diodes) of blue, green and red; or by a white light source with a rotating wheel of color filters.

The imaging device 20 is utilized to implement embodiments shown in FIG. 6 or FIG. 8 for calculating each of the monochrome subfields and mixed subfields according to the components R(p), G(p) and B(p) of each pixel, as well as writing each subfield to the gate driver 14 and source driver 16 in association with corresponding prime color or mixed color synchronously provided by the light module 30 to display each of the monochrome and mixed subfields. The imaging device 20 can be an image timing controller.

To implement the flow of the proposed imaging process method, the imaging device 20 includes a light controller 22, a panel controller 24, a calculator (an arithmetic unit) 26, a comparator 28, a luminance map 32 and a timer 34. The comparator performs step 106-1 or step 206-1. The luminance map 32 implements the predetermined function L(.) used in steps 106-2 and 106-4, or steps 206-2 and 206-4 by LUT of hardware or software. The calculator 26 implements step 106-2 or step 206-2. The panel controller 24 controls the gate driver 14 and the source driver 16; while each of the monochrome and mixed subfields being written by the panel controller 24, the gate driver 14 and the source driver 16 are controlled to drive the panel 12 such that images corresponding to the subfields can be displayed on the panel 12. The light module 22 independently controls each light source of different color channels. The timer 34 coordinates timing of the panel controller 24 and the light controller 22, such that when the light controller 22 controls the light module 30 to provide a color of a single channel, the panel controller 24 synchronously writes a monochrome subfield in association with the single color channel, and when the light controller 22 controls the light module 30 to provide a mixed color combined by two or more color channels, the panel controller 24 synchronously writes a mixed subfield in association with that mixed color. In other words, the timer 34 works with the light controller 22 and the panel controller 24 to implement step 112 of FIG. 6 or step 212 of FIG. 8.

In the imaging device 20 of the invention, each element can be implemented by software, hardware or firmware. The gate driver 14 and the source driver 16 can also be integrated into the imaging device 20; or, some element(s) in the imaging device 20 can be implemented with independent chip(s).

To sum up, comparing to typical FCS imaging method suffering color break, the disclosed technique introduces insertion of mixed subfields to reduce duration of each monochrome subfield, such that a better FCS imaging technique is accomplished with advantages of low power, finer resolution and additional improvement for lowering and avoiding impact of color break experienced in conventional FCS imaging techniques.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for processing at least a frame with an imaging device based on field color sequential (FCS) principle, each frame corresponding to a plurality of pixels, each pixel corresponding to a plurality of color channels and respectively having a corresponding component on each color channel such that components of the plurality of pixels on a same color channel form a corresponding color field, and the method comprising:
for a first color channel of the plurality of color channels, providing a corresponding monochrome subfield for each frame according to a color field corresponding to the first color channel;
for a second color channel and a third color channel of the plurality of color channels, providing a corresponding mixed subfield for each frame according to color fields respectively corresponding to the second color channel and the third color channel; and
according to a predetermined order, writing the monochrome subfield of a frame in association with the first color channel and writing the mixed subfield of the frame in association with a mixed color which is mixed by the second color channel and the third color channel.

2. The method of claim 1, wherein the imaging device comprises a panel controller and a light controller, the light controller independently turns on and off each of a plurality of light sources respectively corresponding to the plurality of color channels; wherein writing the monochrome subfield in association with the first color channel includes: exclusively turning on a light source of the first color channel with the light controller and writing the monochrome subfield with the panel controller synchronously; and writing the mixed subfield in association with the second and the third color channels includes: turning on a light source of the second color channel and a light source of the third color channel with the light controller and writing the mixed subfield with the panel controller synchronously.

3. The method of claim 1, wherein providing the mixed subfield for each frame includes: if a minimum among the plurality of components of a pixel and a minimum among the plurality of components of another pixel are different, providing two different mixed subfield values for the two pixels.

4. The method of claim 1, wherein each component of each pixel distributes between an upper bound and a lower bound, and providing the mixed subfield for each frame includes: if all the components of a pixel are greater than the lower bound, providing a mixed subfield value greater than the lower bound for the pixel.

5. The method of claim 1, wherein providing the monochrome subfield for each frame includes: providing a monochrome subfield value for a pixel which maps to a luminance not greater than a luminance mapped to the first color channel component of the pixel.

6. The method of claim 1, wherein providing the mixed subfield for each frame includes: providing a mixed subfield value for a pixel which maps to a luminance not greater than a luminance mapped to the second color channel component of the pixel and a luminance mapped to the third color channel component of the pixel.

7. The method of claim 1, wherein the first color channel, the second color channel and the third color channel are different.

8. The method of claim 1, wherein providing the mixed subfield for each frame includes: for the first color channel, the second color channel and the third color channel, providing a corresponding mixed subfield for each frame according to color fields respectively corresponding to the first color channel, the second color channel and the third color channel; wherein writing the mixed subfield includes: writing the mixed subfield of the frame in association with the mixed color which is mixed by the first color channel, the second color channel and the third color channel.

9. The method of claim 1, wherein providing the mixed subfield for each frame comprises: for a pixel, obtaining a minimal component by comparing among the plurality of components of the pixel, and determining a mixed subfield value for the pixel according to the minimal component.

10. The method of claim 1, wherein providing the monochrome subfield for each frame comprises: for a pixel, obtaining a minimal component by comparing among the plurality of components of the pixel, and determining a monochrome subfield value for the pixel according to the minimal component and the first color channel component of the pixel.

11. The method of claim 1 further comprising:
according to a complementary order, writing the monochrome subfield of a second frame in association with the first color channel and writing the mixed subfield of the second frame in association with a mixed color which is mixed by the second color channel and the third color channel; wherein the complementary order is different from the predetermined order.

12. A method for processing at least a frame with an imaging device based on field color sequential (FCS) principle, each frame corresponding to a plurality of pixels, each pixel corresponding to a plurality of color channels and respectively having a corresponding component on each color channel, and the method comprising:
for a first color channel of the plurality of color channels, extracting at least a monochrome subfield value and at least a mixed subfield value according to the first color channel component of each pixel of each frame;
according to a predetermined order, writing the monochrome subfield value of each pixel of a frame in association with the first color channel and writing the mixed subfield value of each pixel of the frame in association with at least a second color channel, wherein the first color channel and the second color channel are different.

13. The method of claim 12, wherein writing the mixed subfield value of each pixel includes: writing the mixed subfield value of each pixel in association with a color mixed by two second color channels.

14. The method of claim 12, wherein writing the mixed subfield value of each pixel includes: writing the mixed subfield value of each pixel in association with a color mixed by the first color channel and at least a second color channel.

15. The method of claim 12 further comprising:
obtaining a minimal component by comparing among the plurality of components of each pixel, and determining a mixed subfield value for each pixel according to the minimal component of each pixel.

16. The method of claim 12 further comprising:
according to a complementary order, writing each monochrome subfield value of each pixel of a second frame in association with the first color channel and writing each mixed subfield value of each pixel of the second frame in association with at least the second color channel; wherein the complementary order is different from the predetermined order.

17. An imaging device for processing at least a frame based on FCS principle, each frame corresponding to a plurality of pixels, a p-th pixel corresponding to quantity I of color channels with a component F_i(p) corresponding to an i-th color channel; and the imaging device comprising:
a calculator providing quantity K of mixed subfield values with a k-th mixed subfield value CM_i_k(p) and quantity J of monochrome subfield values with a j-th monochrome subfield value C_i_j(p) for the p-th pixel according to the component F_i(p) of the p-th pixel of each frame, wherein both K and J are greater than or equal to 1;
a light controller independently turning on and off each of a plurality of light sources respectively corresponding to the plurality of color channels; and
a panel controller, while the light controller exclusively turning on a light source of the i-th color channel, the panel controller synchronously writing the monochrome subfield value C_i_j(p) of a frame; and while the light controller turning on at least two light sources of different color channels, the panel controller synchronously writing the mixed subfield value CM_i_k(p) of the frame.

18. The imaging device of claim 17 further comprising:
a comparator obtaining a minimal component for the p-th pixel among components of the p-th pixel corresponding to the quantity I of color channels;
wherein while the comparator obtaining the minimal component F_im(p) from an im-th color channel for the p-th pixel, the calculator further determines the mixed subfield value CM_i_k(p) and the monochrome subfield value C_i_j(p) according to the minimal component F_im(p).

19. The imaging device of claim 18, wherein the calculator first calculates each mixed subfield value CM_im_k(p) and each monochrome subfield value C_im_j(p) of the im-th color channel for the p-th pixel, and then calculates at least a mixed subfield value CM_i_k(p) for another i-th color channel according to each mixed subfield value CM_im_k(p), and further calculates each monochrome subfield value C_i_j(p) according to each component F_i(p).

20. The imaging device of claim 19, wherein when the calculator calculates at least a mixed subfield value CM_i_k(p) for another i-the color channel according to each mixed subfield value CM_im_k(p), the calculator sets a mixed subfield value CM_i_k1(p) of the i-th color channel equal to a mixed subfield value CM_im_k2(p) of the im-th color channel.

21. The imaging device of claim 19, wherein when the calculator calculates each mixed subfield value CM_im_k(p) of the im-th color channel, the calculator sets all quantity K of mixed subfield values CM_im_k(p) equal to each other.

22. The imaging device of claim 17 further comprising:
a luminance map for mapping each component F_i(p) to a corresponding luminance.

23. The imaging device of claim 17, wherein the panel controller synchronously writes the monochrome subfield value C_i_j(p) of a frame while the light controller exclusively turns on a light source of the i-th color channel, and synchronously writes the mixed subfield value CM_i_k(p) of the frame while the light controller turns on at least two light sources of different color channels according to a predetermined order; and the panel controller further writes the monochrome subfield value C_i_j(p) of a second frame while the light controller exclusively turns on a light source of the i-th color channel, and synchronously writes the mixed subfield value CM_i_k(p) of the second frame while the light controller turns on at least two light sources of different color channels according to a complementary order; the predetermined order and the complementary order are different.
